(19) United States
(12) Patent Application Publication
(10) Pub. No.: US 2007/0153155 A1
(43) Pub. Date: Jul. 5, 2007

(54) LIQUID CRYSTAL DISPLAY AND METHOD OF MANUFACTURING THE SAME

(75) Inventors: Du-hwan CHUNG, Suwon-si, Gyeonggi-do (KR); Seok-won LEE, Yongin-si, Gyeonggi-do (KR); Choong-sik KIM, Anyang-si, Gyeonggi-do (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD, Suwon-si (KR)

(21) Appl. No.: 11/619,370

(22) Filed: Jan. 3, 2007

(30) Foreign Application Priority Data
Jan. 4, 2006 (KR) 10-2006-0001000

(51) Int. Cl. G02F 1/1333; G02F 1/1335

(52) U.S. Cl. 349/58; 349/65

(57) ABSTRACT

A liquid crystal display (“LCD”) includes an LCD panel, a light guiding plate disposed beneath the LCD panel, a light source part disposed at a lateral side of the light guiding plate, a cover comprising a first surface parallel with the light guiding plate and a second surface extending from the first surface, and accommodating the light guiding plate and the light source part, and a light source cover which encompasses the light source part, reflects light from the light source part to the light guiding plate, and comprises an expansion part protruded toward the cover to contact the cover.

This application claims priority to Korean Patent Application No. 2006-0001000, filed on Jan. 4, 2006, and all the benefits accruing therefrom under 35 U.S.C. §119, the contents of which in its entirety are herein incorporated by reference.

### BACKGROUND OF THE INVENTION

1. Field of the Invention

The present invention relates to a liquid crystal display (“LCD”), and more particularly, to an LCD in which a light source cover contacts a cover to efficiently radiate heat from a light source part.

2. Description of the Related Art

Recently, flat panel displays, such as a liquid crystal display (“LCD”), a plasma display panel (“PDP”), an organic light emitting diode (“OLED”) and various other display types, have been used in place of a cathode ray tubes (“CRTs”).

The typical LCD comprises an LCD panel including a thin film transistor (“TFT”) substrate, a color filter substrate and liquid crystals interposed between both substrates. The LCD does not emit light by itself, and thus there is a backlight unit disposed behind the TFT substrate to provide light thereto. Transmittance of the light from the backlight unit through the LCD panel is controlled depending on an arrangement of the liquid crystals. The liquid crystals of the LCD panel may be twisted to allow light to pass therethrough, they may be twisted to block light from passing therethrough, or they may be twisted so that only a fraction of the light provided from the backlight travels therethrough. The LCD further comprises a cover to accommodate the LCD panel and the backlight unit.

The backlight unit may either be edge-type or direct-type depending on a position of the light source part. In an edge-type backlight unit, a light source part is mounted at a lateral side of a light guiding plate. The edge-type backlight unit is typically employed in a relatively small-sized LCD, such as a monitor for a laptop computer or a desktop computer. The edge-type backlight unit has high light uniformity and a long life-time, and is also especially suited to make thin LCDs.

However, in an LCD using the edge-type backlight unit, heat is generated in the light source part. If the heat is not efficiently radiated, it may cause the liquid crystals to change from a liquid crystal phase to a liquid phase, thereby preventing the display of images thereon. Moreover, as a high voltage is applied to the light source part, as may be necessary for increased luminosity, the undesirable phase changing of the liquid crystals is exacerbated.

### BRIEF SUMMARY OF THE INVENTION

Accordingly, it is an aspect of the present invention to provide a liquid crystal display (“LCD”) which efficiently radiates heat from a light source part.

The foregoing and/or other aspects, features and advantages of the present invention are achieved by providing an LCD including; an LCD panel, a light guiding plate disposed below the LCD panel, a light source part disposed at least at a lateral side of the light guiding plate, a lower cover including a first surface substantially parallel with the light guiding plate and a second surface which extends from the first surface, wherein the lower cover accommodates the light guiding plate and the light source part, and a light source cover which at least partially encompasses the light source part, reflects light from the light source part to the light guiding plate, and includes at least one expansion part which protrudes toward the lower cover to contact the lower cover.

Accordingly to an exemplary embodiment of the present invention, the light source cover includes; a lower surface facing the first surface, a lateral surface which extends from the lower surface and faces the second surface, and an upper surface which extends from the lateral surface toward the light guiding plate.

Accordingly to an exemplary embodiment of the present invention, the expansion part is also formed on the lower surface.

Accordingly to an exemplary embodiment of the present invention, the expansion part is further formed on the lateral surface.

Accordingly to an exemplary embodiment of the present invention, the lower surface includes an extension part which extends between the light guiding plate and the first surface.

Accordingly to an exemplary embodiment of the present invention, the light source part includes a light source and electrodes disposed at opposite ends of the light source, and the expansion part is formed on a portion of the light source cover corresponding to the electrodes.

Accordingly to an exemplary embodiment of the present invention, the light source part includes LEDs, and the expansion part is formed on substantially the middle of the light source cover.

Accordingly to an exemplary embodiment of the present invention, the expansion part of the light source cover has substantially the same thickness as the light source cover.

Accordingly to an exemplary embodiment of the present invention, the light source cover includes an inner layer which faces the light source part and an outer layer formed adjacent and opposite to the inner layer.

Accordingly to an exemplary embodiment of the present invention, the inner layer includes polyethylene terephthalate (“PET”) and the outer layer includes aluminum.

Accordingly to an exemplary embodiment of the present invention, the lower cover includes an aluminum plate or a galvanized zinc plate.

Accordingly to an exemplary embodiment of the present invention, the LCD further includes a reflecting plate disposed between the light guiding plate and the first surface, wherein the expansion part is spaced away from the reflecting plate.

The foregoing and/or other aspects, features and advantages of the present invention are achieved by providing an exemplary embodiment of an LCD including; an LCD panel, a light guiding plate disposed below the LCD panel, a light source part disposed at least at a lateral side of the light guiding plate, a light source cover which reflects light from the light source part to the light guiding plate and at least partially encompasses the light source part, and a lower cover including a first surface substantially parallel to the light guiding plate and a second surface extending from the first surface to form a space, where the space accommodates the light guiding plate and the light source part, and wherein the lower cover further includes an expansion part which protrudes toward the light source cover and contacts the light source cover.

Accordingly to an exemplary embodiment of the present invention, the light source cover includes; a lower surface which faces the first surface, a lateral surface which extends from the lower surface and faces the second surface, and an upper surface which extends from the lateral surface toward the light guiding plate.

Accordingly to an exemplary embodiment of the present invention, the expansion part is formed on the first surface.

Accordingly to an exemplary embodiment of the present invention, the expansion part is further formed on the second surface.

Accordingly to an exemplary embodiment of the present invention, the light source part includes a light source and electrodes disposed at opposite ends of the light source, and the expansion part is formed on a portion of the light source cover corresponding to the electrodes.

Accordingly to an exemplary embodiment of the present invention, the expansion part has substantially the same thickness as the lower cover.

Accordingly to an exemplary embodiment of the present invention, the lower cover includes an aluminum plate or a galvanized zinc plate.

Accordingly to an exemplary embodiment of the present invention, the LCD further includes a reflecting plate disposed between the light guiding plate and the first surface, wherein the expansion part is spaced away from the reflecting plate.

The foregoing and/or other aspects, features and advantages of the present invention are achieved by providing an exemplary embodiment of a method of manufacturing a liquid crystal display, the method including; forming an LCD panel, forming a light guiding plate below the LCD panel, forming a light source part at least at a lateral side of the light guiding plate, forming a lower cover including a first surface substantially parallel with the light guiding plate and a second surface which extends from the first surface, wherein the lower cover accommodates the light guiding plate and the light source part, and forming a light source cover which at least partially encompasses the light source part, reflects light from the light source part to the light guiding plate, and includes at least one expansion part which protrudes toward the lower cover to contact the lower cover.

### BRIEF DESCRIPTION OF THE DRAWINGS

The above and/or other aspects, features and advantages of the present invention will become apparent and more readily appreciated from the following description of the exemplary embodiments, taken in conjunction with the accompanying drawings of which:

FIG. 1 is an exploded perspective view of a first exemplary embodiment of an LCD according to the present invention;

FIG. 2 is a cross-sectional view of the first exemplary embodiment of an LCD according to the present invention;

FIG. 3 is an enlarged view of the area A shown in FIG. 2;

FIG. 4 is a perspective view illustrating a relationship between an exemplary embodiment of a light source cover and an exemplary embodiment of a light source part in the LCD according to the first exemplary embodiment of the present invention;

FIG. 5 is a perspective view illustrating a second exemplary embodiment of a light source cover according to the present invention;

FIG. 6 is a perspective view illustrating a third exemplary embodiment of a light source cover according to the present invention;

FIG. 7A is a front perspective view illustrating a fourth exemplary embodiment of a light source cover according to the present invention;

FIG. 7B is a perspective view of the fourth exemplary embodiment of a light source cover according to the present invention as seen from the perspective of the light guide plate; and

FIG. 8 is an enlarged view of a cross-section of a fifth exemplary embodiment of an LCD according to the present invention.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Reference will now be made in more detail to exemplary embodiments of the present invention, examples of which are illustrated in the accompanying drawings

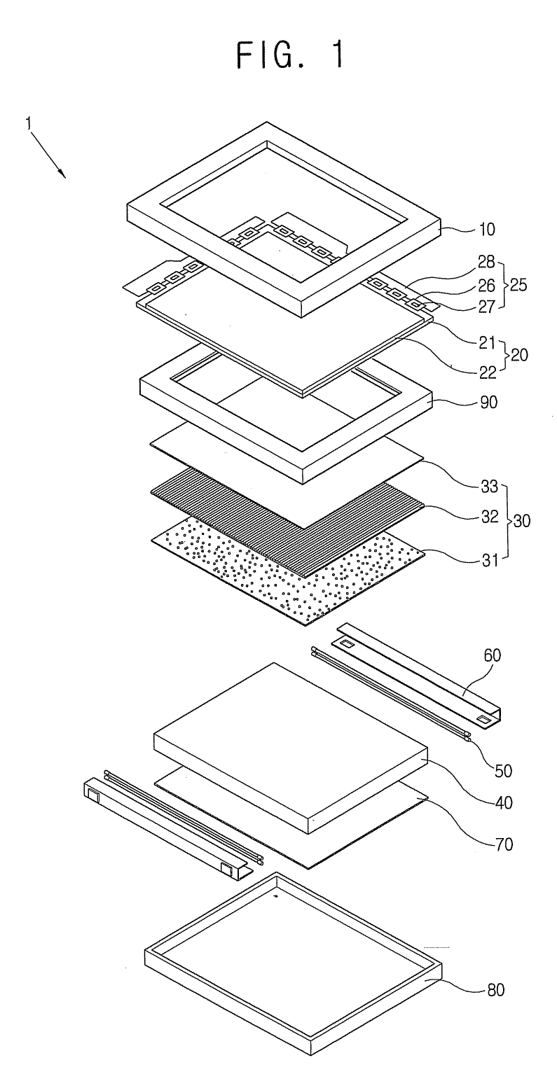

Hereinafter, a first exemplary embodiment of an LCD according to the present invention will be described with reference to FIGS. 1 through 4.

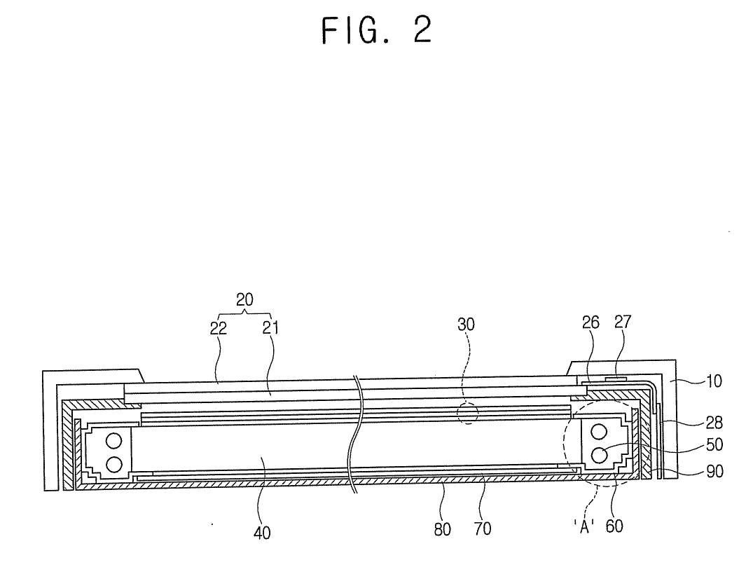

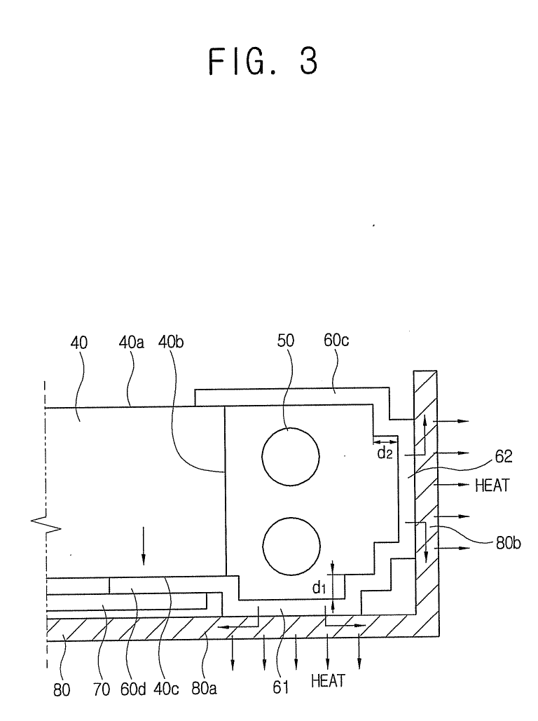

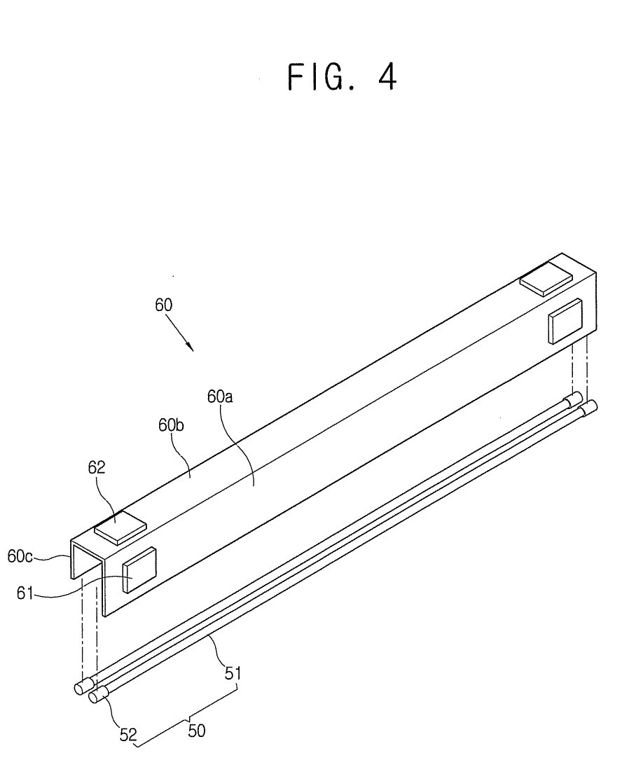

FIG. 1 is an exploded perspective view of a first exemplary embodiment of an LCD according to the present invention; FIG. 2 is a cross-sectional view of the first exemplary embodiment of an LCD according to the present invention; FIG. 3 is an enlarged view of the area A shown in FIG. 2; and FIG. 4 is a perspective view illustrating a relationship between an exemplary embodiment of a light source cover and an exemplary embodiment of a light source part in the LCD according to the first exemplary embodiment of the present invention.

An LCD 1 comprises an LCD panel 20, an optical film 30 disposed below the LCD panel 20, a light guiding plate 40 disposed below the optical film 30, a pair of light source parts 50 disposed along opposite lateral sides of the light guiding plate 40, a light source cover 60 encompassing the light source parts 50, and a reflecting plate 70 disposed under the light guiding plate 40. These are accommodated between an upper cover 10 and a lower cover 80. For further protection and stability, the LCD panel 20 may be seated in a mold 90.

The LCD panel 20 comprises a TFT substrate 21, wherein a plurality of TFTs are disposed thereon, and a color filter substrate 22 disposed on the TFT substrate 21. A liquid crystal layer (not shown) is disposed between the TFT substrate 21 and the color filter substrate 22. The LCD panel 20 controls arrangement of liquid crystal molecules within the liquid crystal layer. The plurality of TFTs allows for a plurality of pixels to be independently controlled. With each pixel either blocking or transmitting light therethrough an image may be formed thereon. However, in order to form an image the LCD panel 20 must be provided with light. The light is provided from the light source parts 50 disposed at its rear, since the LCD panel does not emit light by itself.

A driving part 25 applying a driving signal is provided at one side of the TFT substrate 21. The driving part 25 comprises a flexible printed circuit (“FPC”) 26, a driving chip 27 mounted on the FPC 26 and a printed circuit board (“PCB”) 28 connected to one side of the FPC 26. The exemplary embodiment of a driving part 25 shown in FIGS. 1 and 2 is a chip on film (“COF”) type. However, alternative exemplary embodiments include any of several well-known configurations, such as a tape carrier package (“TCP”), a chip on glass (“COG”) or other similar configurations, may be used for the driving part 25. Further, other alternative exemplary embodiments include configurations wherein the driving part 25 may be formed on the TFT substrate 21.

The exemplary embodiment of an optical film 30 disposed below the LCD panel 20 comprises a diffusion film 31, a prism film 32 and a protection film 33.

In one exemplary embodiment the diffusion film 31 comprises a base plate and a coating layer having beads formed on the base plate. The diffusion film 31 diffuses light from the light source parts 50 to be provided to the LCD panel 20. Alternative exemplary embodiments include configurations wherein two or three diffusion films 31 may be used layered on each other.

In one exemplary embodiment the prism film 32 comprises triangular prisms formed in a predetermined arrangement thereon. The prism film 32 collects the light diffused from the diffusion film 31 and refracts it perpendicularly to a surface of the LCD panel 20; the light is then planar to the LCD panel 20. Typically, two prism films 32 are used, and micro prisms formed on each of the prism films 32 make a predetermined angle with each other. Most of the light passing through the prism film 32 progresses perpendicularly therethrough, thereby forming a uniform brightness distribution.

The protection film 33 disposed above the optical member 30 protects the prism film 32, which is vulnerable to scratching.

Exemplary embodiments of the light guiding plate 40 may be made of acrylic resin. The light guiding plate 40 uniformly provides the light from the light source parts 50 to the diffusion film 31. The light guiding plate 40 may have a rectangular shape comprising an exiting surface 40a facing the diffusion film 31, a pair of incident surfaces 40b facing the light source parts 50 and a reflecting surface 40c facing the reflecting plate 70.

Each of the light source parts 50 is disposed with its longitudinal axis substantially parallel to the pair of incident surfaces 50b of the light guiding plate 40. Each of the light source parts 50 in the present exemplary embodiment comprises a lamp, the lamp comprising a light source 51 and electrodes 52 disposed at opposite ends of the light source 51. The light source parts 50 may be a cold cathode fluorescent lamp (“CCFL”), an external electrode fluorescent lamp (“EEFL”) or various other light sources.

The light source cover 60 and the incident surfaces 40b of the light guiding plate 40 encompass the light source part 50. The light source cover 60 reflects the light from the light source parts 50 toward the light guiding plate 40. In one exemplary embodiment the light source cover 60 has double layers, an exemplary embodiments of which include an inner layer comprising polyethylene terephthalate (“PET”) and an outer layer comprising aluminum, which has excellent thermal conductivity.

The light source cover 60 comprises a lower surface 60a which faces a first surface 80a of the lower cover 80, a lateral surface 60b extending from the lower surface 60a and facing a second surface 80b of the lower cover 80, and an upper surface 60c extending from the lateral surface 60b toward the light guiding plate 40. A portion of the lower surface 60a forms an extension part 60d extended between the first surface 80a of the lower cover 80 and the light guiding plate 40. The upper surface 60c partially overlaps the exiting surface 40a of the light guiding plate 40.

In the current exemplary embodiment a first expansion part 61 is formed on the lower surface 60a of the light source cover 60. The first expansion part 61 is protruded toward the first surface 80a of the lower cover 80 to contact the first surface 80a. A second expansion part 62 is formed on the lateral surface 60b of the light source cover 60. The second expansion part 62 is protruded toward the second surface 80b of the lower cover 80 to contact the second surface 80b. In the present exemplary embodiment the light source cover 60 has a substantially uniform thickness throughout, and thus when viewed from the perspective of the light source 51 the first expansion part 61 and the second expansion part 62 appear substantially convex in comparison with the rest of the light source cover 60. In one exemplary embodiment, the light source cover 60 is manufactured by pressing a uniform thickness plate having double layers, including a PET layer inside and an aluminum layer outside.

First expansion parts 61 and second expansion parts 62 are also formed at opposite ends of the light source cover 60 to correspond to the electrodes 52 of the light source part 50. The function of the first expansion part 61 and the second expansion part 62 will be described later.

The reflecting plate 70 is disposed under the light guiding plate 40 and reflects light incident thereon back to the light guiding plate 40. Exemplary embodiments of the reflecting plate 70 may comprise polyethylene terephthalate (“PET”) or polycatbonate (“PC”). The reflecting plate 70 is disposed away from the first expansion part 61 so as to not overlap with each other.

The lower cover 80 comprises the first surface 80a facing the reflecting surface 40c of the light guiding plate 40, and the second surface 80b extending from the first surface 80a to face the incident surface 40b of the light guiding plate 40. The first surface 80a and the second surface 80b form a space where the light guiding plate 40, the light source parts 50 and the light source cover 60 are accommodated. Exemplary embodiments of the lower cover 80 may comprise an aluminum plate or a zinc galvanizing plate.

Hereinafter, the first exemplary embodiments of the expansion part 61 and the second expansion part 62 according to the present invention will be described with respect to their functions.

Heat is generated in the light source parts 50 when the LCD 1 is driven and during the operation of the light source parts 50. Specially, a relatively large portion of the heat is generated in the electrodes 52 of the light source parts 50. Accordingly, a phase change of the liquid crystal layer occurs around corners of the LCD panel 20, so that the LCD panel 20 does not form an image but displays black around the corners.

The heat generated in the light source parts 50 is transmitted to the light source cover 60, the light guiding plate 40, the optical sheet 30 and other parts of the LCD, wherein about 60% of total heat is radiated to the lower cover 80 through the light source cover 60.

Thus, when a contact between the light source cover 60 and the lower cover 80 improves, the heat from the light source parts 50 may be radiated more efficiently. Specially, if the contact between the light source cover 60 and the lower cover 80 improves near the electrodes 52, the heat may be radiated even more efficiently.

In the first exemplary embodiment, the first expansion part 61 contacts with the first surface 80a of the lower cover 80, and the second expansion part 62 contacts with the second surface 80b of the lower cover 80, thereby efficiently transmitting the heat from the light source parts 50 to the lower cover 80. The lower cover 80 radiates the heat through its relatively large surface area to the outside.

The first expansion part 61 and the second expansion part 62 are protruded toward the lower cover 80, and thus they may easily contact the lower cover 80. Further, the light guiding plate 40 presses the extension part 60d adjacent to the first expansion part 61 toward the first surface 80a of the lower cover 80, so that the first expansion part 61 may closely contact the lower cover 80. Meanwhile, an assembly margin between the second expansion part 62 and the second surface 80b is adjusted to be tight, so that it ensures that the second expansion part 62 may contact with the second surface 80b of the lower cover 80. The reflecting plate 70 is disposed so that the first expansion part 61 and the first surface 80a may come into contact, thereby the reflecting plate 70 does not influence thermal conduction. The thicknesses d1 and d2 of the expansion parts 61 and 62, respectively may be in a range of about 0.05 mm to about 2 mm. The thicknesses d1 and d2 may either be substantially similar as shown in FIG. 2 or they may vary independently.

As described above, the heat from the light source part 50 may be radiated efficiently. Specifically, the heat around the electrodes 52 is intensively radiated, thereby reducing or effectively preventing a phase change of the liquid crystal layer in the corners.

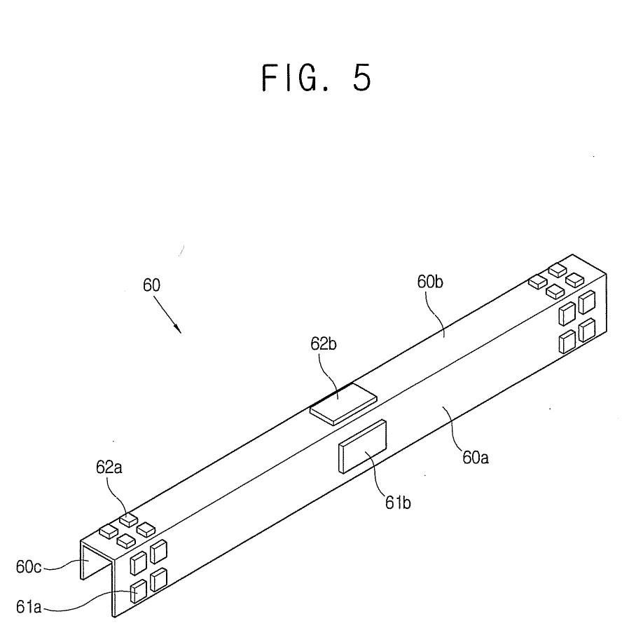

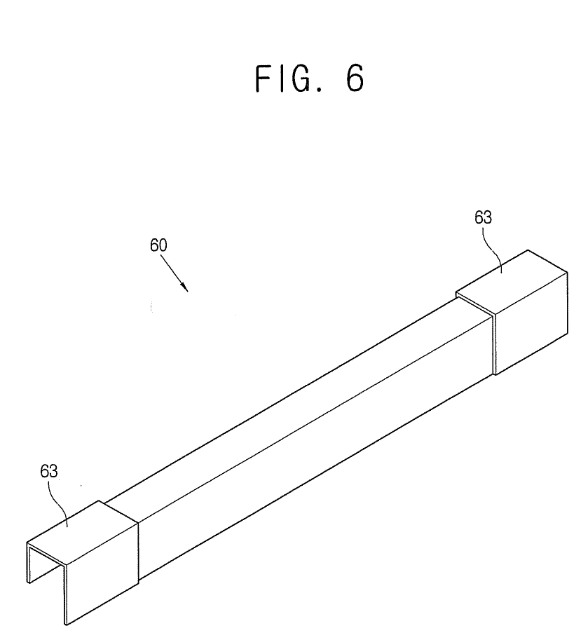

FIGS. 5 and 6 are perspective views illustrating second and third exemplary embodiments of a light source cover according to the present invention, respectively.

In a second exemplary embodiment shown in FIG. 5, expansion parts 61b and 62b are provided on the middle of a light source cover 60 and additional expansion parts 61a and 62a are disposed at opposite ends of the light source cover 60. Further, the expansion parts disposed at the opposite ends comprise a plurality of sub-expansion parts 61a and 62a. The expansion parts 61a, 61b, 62a and 62b allow the light source cover 60 to stably contact a lower cover 80.

The expansion parts 61a, 61b, 62a and 62b may be modified variously in configuration, number and position in order to improve the radiating characteristics and manufacturing convenience thereof.

In the third exemplary embodiment shown in FIG. 6, the entire opposite ends of a light source cover 60 form expansion parts 63. In this exemplary embodiment the surface area for radiative contact between the light source cover 60 and the lower cover 80 is maximized at the opposing ends of the light source cover 60.

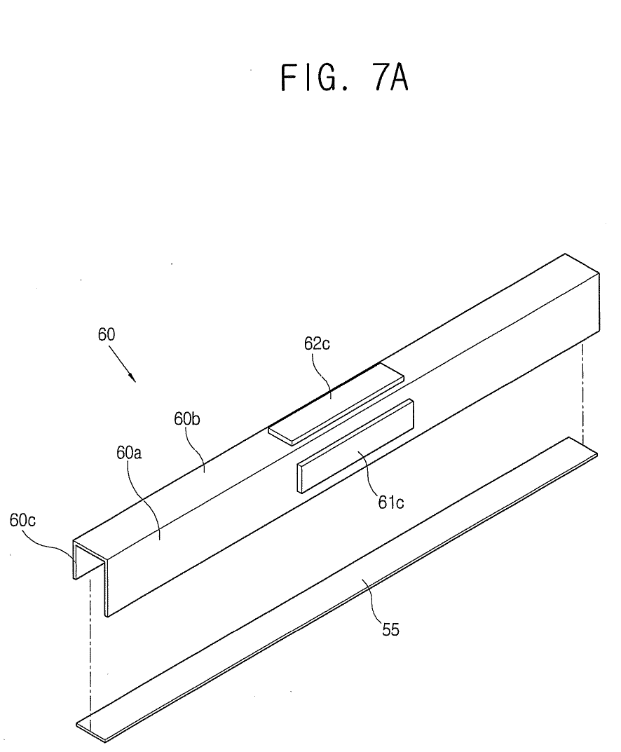

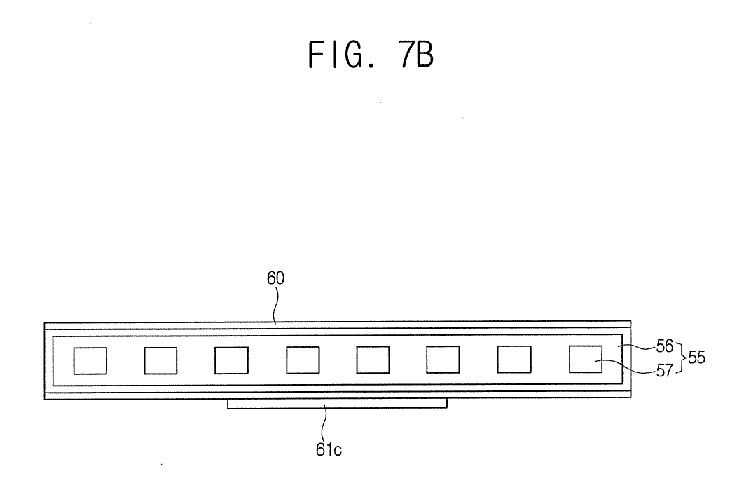

FIGS. 7A is a front perspective view illustrating a fourth exemplary embodiment of a light source cover according to the present invention and FIG. 7B is a perspective view of the fourth exemplary embodiment of a light source cover as seen from the perspective of the light guide plate.

A light source part 55 according to a fourth exemplary embodiment comprises a circuit board 56 and light emitting diodes (“LEDs”) 57. The circuit board 56 has a plate shape and anterior and posterior sides. Its posterior side is disposed proximate to a lateral surface 60b of a light source cover 60. In the present exemplary embodiment the LEDs 57 are seated so as to be regularly spaced on the anterior side of the circuit board 56. Alternative exemplary embodiments include configurations wherein the LEDs 57 may be spaced irregularly on the circuit board 56. In the present exemplary embodiment the LEDs 57 have good brightness and color reproducibility. In one exemplary embodiment the LEDs 57 emit red light, green light and blue light to be mixed with each other to provide white light. Alternative exemplary embodiments include configurations wherein the LEDs 57 emit white light.

Expansion parts 61c and 62c are formed on the middle of the light source cover 60 in the fourth embodiment of a light source cover. When LEDs 57 are used heat is generated more in the middle of the light source cover 60 than at opposite ends thereof.

Although as shown the thickness of the light source cover 60 according to the second through the fourth exemplary embodiment is substantially uniform, alternative exemplary embodiments include configurations wherein the thickness of the light source cover 60 may vary.

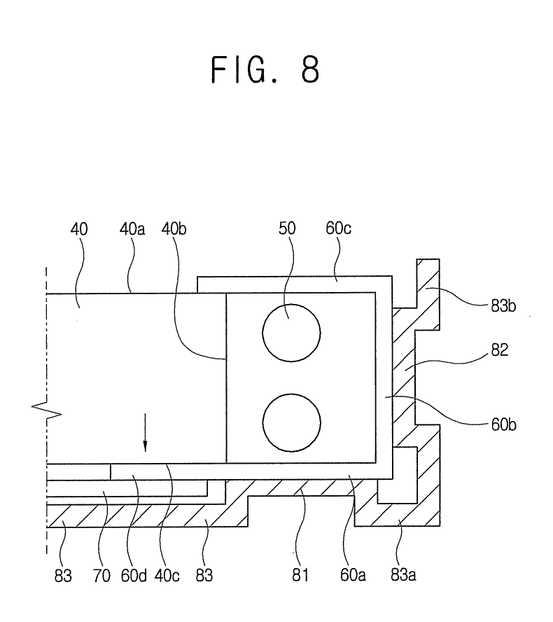

FIG. 8 is an enlarged view of a cross-section of a fifth exemplary embodiment of an LCD according to the present invention.

In the present exemplary embodiment, cover expansion parts 81 and 82 are provided in a lower cover 83. The cover expansion parts 81 and 82 comprise a first cover expansion part 81 protruded from a first surface 83a of the lower cover 83 to contact with a lower surface 60a of a light source cover 60, and a second cover expansion part 82 protruded from a second surface 83b of the lower cover 83 to contact with a lateral surface 60b of the light source cover 60.

Although the thickness of the lower cover 83 is shown to be substantially uniform with respect to FIG. 8, alternative exemplary embodiments include configurations wherein the thickness of the lower cover 83 may vary.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A liquid crystal display (LCD) comprising:
an LCD panel;
a light guiding plate disposed below the LCD panel;
a light source part disposed at least at a lateral side of the light guiding plate;
a lower cover comprising a first surface substantially parallel with the light guiding plate and a second surface which extends from the first surface, wherein the lower cover accommodates the light guiding plate and the light source part; and
a light source cover which at least partially encompasses the light source part, reflects light from the light source part to the light guiding plate, and comprises at least one expansion part which protrudes toward the lower cover to contact the lower cover.

2. The LCD according to claim 1, wherein the light source cover comprises
a lower surface facing the first surface;
a lateral surface which extends from the lower surface and faces the second surface; and
an upper surface which extends from the lateral surface toward the light guiding plate.

3. The LCD according to claim 2, wherein the expansion part is also formed on the lower surface.

4. The LCD according to claim 3, wherein the expansion part is further formed on the lateral surface.

5. The LCD according to claim 3, wherein the lower surface comprises an extension part which extends between the light guiding plate and the first surface.

6. The LCD according to claim 3, wherein the light source part comprises a light source and electrodes disposed at opposite ends of the light source, and the expansion part is formed on a portion of the light source cover corresponding to the electrodes.

7. The LCD according to claim 3, wherein the light source part comprises LEDs, and the expansion part is formed on substantially the middle of the light source cover.

8. The LCD according to claim 1, wherein the expansion part of the light source cover has substantially the same thickness as the light source cover.

9. The LCD according to claim 1, wherein the light source cover comprises an inner layer which faces the light source part and an outer layer formed adjacent and opposite to the inner layer.

10. The LCD according to claim 9, wherein the inner layer comprises polyethylene terephthalate (PET) and the outer layer comprises aluminum.

11. The LCD according to claim 1, wherein the lower cover comprises an aluminum plate or a galvanized zinc plate.

12. The LCD according to claim 1, further comprising a reflecting plate disposed between the light guiding plate and the first surface, wherein the expansion part is spaced away from the reflecting plate.

13. A liquid crystal display (LCD) comprising:
an LCD panel;
a light guiding plate disposed below the LCD panel;
a light source part disposed at least at a lateral side of the light guiding plate;
a light source cover which reflects light from the light source part to the light guiding plate and at least partially encompasses the light source part; and
a lower cover comprising a first surface substantially parallel to the light guiding plate and a second surface extending from the first surface to form a space, wherein the space accommodates the light guiding plate and the light source part, and wherein the lower cover further comprises an expansion part which protrudes toward the light source cover and contacts the light source cover.

14. The LCD according to claim 13, wherein the light source cover comprises:
a lower surface which faces the first surface;
a lateral surface which extends from the lower surface and faces the second surface;
and an upper surface which exetends from the lateral surface toward the light guiding plate.

15. The LCD according to claim 14, wherein the expansion part is formed on the first surface.

16. The LCD according to claim 15, wherein the expansion part is further formed on the second surface.

17. The LCD according to claim 15, wherein the light source part comprises a light source and electrodes disposed at opposite ends of the light source, and the expansion part is formed on a portion of the light source cover corresponding to the electrodes.

18. The LCD according to claim 15, wherein the expansion part has substantially the same thickness as the lower cover.

19. The LCD according to claim 13, wherein the lower cover comprises an aluminum plate or a galvanized zinc plate.

20. The LCD according to claim 13, further comprising a reflecting plate disposed between the light guiding plate and the first surface, wherein the expansion part is spaced away from the reflecting plate.

21. A method of manufacturing a liquid crystal display (LCD), the method comprising:
forming an LCD panel;
forming a light guiding plate below the LCD panel;
forming a light source part at least at a lateral side of the light guiding plate;
forming a lower cover comprising a first surface substantially parallel with the light guiding plate and a second surface which extends from the first surface, wherein the lower cover accommodates the light guiding plate and the light source part; and
forming a light source cover which at least partially encompasses the light source part, reflects light from the light source part to the light guiding plate, and comprises at least one expansion part which protrudes toward the lower cover to contact the lower cover.
